(19) United States
(12) Patent Application Publication
(10) Pub. No.: US 2026/0057054 A1
(43) Pub. Date: Feb. 26, 2026

(54) Method and device for behavioural biometric authentification

(71) Applicant: WORLDLINE, PUTEAUX (CN)

(72) Inventors: Pierrick LEFEVRE, WATTIGNIES (FR); Wael ELLOUMI, BLOIS (FR); Frédéric VIEREN, LOOS EN GOHELLE (FR); Benjamin LOPEZ, SECLIN (FR)

(21) Appl. No.: 19/104,770

(22) PCT Filed: Aug. 18, 2023
(86) PCT No.: PCT/FR2023/051278

§ 371 Date: Feb. 19, 2025

(30) Foreign Application Priority Data
Aug. 19, 2022 (FR) 2208401

(51) Int. Cl. G06F 21/32

(52) U.S. Cl. CPC G06F 21/32

(57) ABSTRACT

The invention relates to a method for behavioral biometric authentication of a user interacting with an application system by means of at least one interaction device, which comprises: obtaining (530) values of characteristic parameters of the user's behavior determined from events produced by the user's interaction with the interaction device; determining (540) a first score by applying a behavioral model of the legitimate user to the values of the characteristic parameters; determining (550) second scores by respectively applying each of the behavioral models of the reference users to the values of the characteristic parameters; and determining (560) a decision to authenticate the user as being the legitimate user on the basis of the first score and the second scores.

### TECHNICAL FIELD

The present description relates to a method and device for behavioral biometric authentication.

### TECHNICAL BACKGROUND

In the context of video games, passwords are used to secure user accounts on game consoles: many users use passwords to protect their accounts from access by other people (such as friends or family members). To enter a password, a user generally has to use a virtual keyboard on a screen (television for example) navigated via their game console.

When payment is required, users can save their payment information in their account and set a password, which may be the account's password or be a password specific to payment transactions in order to add an extra layer of security during payment (in case of console theft or to prevent others from buying games from their account). Such a measure can lead to breaks or interruptions in the video game for users as they attempt to validate a transaction. In addition, users still cannot prevent payment if others manage to obtain their passwords.

Furthermore, strong authentication may be required for payments on a digital platform associated with the video game: strong authentication can lead to unwanted “friction”, interruptions or breaks for users when making payments via the platform, since most of the time users will need to use another device (e.g. a cellphone) to finalize authentication and validate the transaction.

There is thus a need for a strong authentication solution that is suitable for video games or other application contexts where strong authentication may be required at any time during the user's interaction with a given application system.

### SUMMARY

The scope of protection is defined by the claims.

According to a first aspect, the present description relates to a method for behavioral biometric authentication of a user interacting with an application system by means of at least one interaction device. The method comprises
obtaining behavioral biometric models of reference users;
obtaining a behavioral biometric model of a legitimate user, the behavioral biometric model of a legitimate user, respectively of a reference user, being configured to receive, as input, values of characteristic parameters of the behavior of the considered user during interaction actions with the interaction device and to generate, as output, a score representative of a probability that the behavior represented by the input values of the characteristic parameter is that of the considered user;
obtaining values of characteristic parameters of the user's behavior which are determined from events produced by the user's interaction actions with the interaction device;
determining a first score by applying the behavioral biometric model of the legitimate user to the values of the characteristic parameters;
determining second scores by respectively applying each of the behavioral biometric models of the reference users to the values of the characteristic parameters;
determining a decision to authenticate the user as being the legitimate user on the basis of the first score and the second scores.

According to one or more embodiments, the first score represents a probability that the user is the legitimate user.

According to one or more embodiments, each second score represents a probability that the user is a reference user associated with the behavioral model used to generate the considered score.

According to one or more embodiments, the steps of determining the first score, the second scores and the decision to authenticate are repeated for characteristic parameter values respectively obtained for a temporal sequence of time intervals, the method comprising
updating the current value of a weight for each time interval, the weight being decremented if one of the second scores obtained for this time interval is greater than an authentication threshold, the weight being incremented if the first score obtained for this time interval is greater than the authentication threshold;
the first score obtained for a time interval being modified by adding the current value of the weight after updating for this time interval, the modified first score being used to determine the decision to authenticate.

According to one or more embodiments,
the decision to authenticate is negative if the first score is below an authentication threshold;
the decision to authenticate is negative if the first score is above an authentication threshold and at least one of the second scores is above the authentication threshold; and
the decision to authenticate is positive if the first score is above an authentication threshold and all of the second scores are below the authentication threshold.

According to one or more embodiments,
the decision to authenticate is negative if the first score is below an authentication threshold;
the decision to authenticate is positive if the first score is above an authentication threshold and fewer than N second scores are above the authentication threshold;
the decision to authenticate is negative if the first score is above an authentication threshold and at least N or more second scores are above the authentication threshold.

According to one or more embodiments, N is an integer strictly greater than 1 and smaller than or equal to 10.

According to one or more embodiments, the reference users are users different from the legitimate user.

According to one or more embodiments, the behavioral models of the reference users are the most discriminating behavioral models from among a set of reference user behavioral models.

According to one or more embodiments, the application system is a video game system.

According to a second aspect, the present description relates to a device comprising means for implementing a method according to the first aspect.

The means may be software and/or hardware means. These means may comprise, for example, one or more circuits configured to execute one or more or all of the steps of one of the method according to the first aspect. The means may comprise, for example, at least one processor and at least one memory comprising program instructions configured to cause, when executed by the processor, the device to execute one or more or all of the steps of one of the method according to the first aspect.

According to another aspect, the present description relates to a storage medium that is readable by a data processor on which is stored a program comprising program instructions configured to cause the data processor to execute one or more or all of the steps of the method according to the first aspect. According to another aspect, the present description relates to a computer program comprising program instructions configured to cause a data processor to execute one or more or all of the steps of the method according to the first aspect.

### BRIEF DESCRIPTION OF THE FIGURES

Further features and advantages will become apparent from the following detailed description, based on illustrative and non-limiting embodiments and examples, with reference to the accompanying figures.

FIG. 1 shows a block diagram illustrating a phase in the creation of reference behavioral models according to an exemplary embodiment.

FIG. 2 shows a block diagram illustrating a phase of enrollment of one or more legitimate users according to an exemplary embodiment.

FIG. 3 shows a block diagram illustrating a phase of authenticating a user according to an exemplary embodiment.

FIG. 4 shows a block diagram illustrating a phase of updating a legitimate user's biometric template according to an exemplary embodiment.

FIG. 5 shows a flowchart of a method for behavioral biometric authentication according to an exemplary embodiment.

FIG. 6 schematically shows a system including a behavioral biometric authentication device according to an exemplary embodiment.

FIG. 7 is a diagram showing the performance of a behavioral biometric authentication method according to an exemplary embodiment.

FIG. 8 is a diagram showing the performance of a behavioral biometric authentication method according to an exemplary embodiment.

### DETAILED DESCRIPTION

Various embodiments will now be described in more detail with reference to the drawings. The specific structural and/or functional details disclosed here are used to provide an understanding of the various possible embodiments. However, a person skilled in the art will understand that the exemplary embodiments may be subject to various modifications and may be implemented without all of these details.

The present description relates to transparent behavioral biometric authentication method and device that makes the steps in authentication smoother, simplifies the user experience, provides a “frictionless” experience and validation of transactions while ensuring a high level of security.

This method also makes it possible to authenticate, during a user experience, that the user is indeed the legitimate user and is not being spoofed or assisted by cheating means, i.e. that the legitimate user is not a cheater.

This authentication system is based on biometric behavioral data collected during the user's interactions with an application system. These biometric behavioral data are used to train behavioral models of reference users, in particular users other than the legitimate user, by means of machine learning.

Behavioral biometrics is based on the analysis of a person's behavioral characteristics, such as the way a person interacts with a device or system. Behavioral biometrics differs from physiological biometrics, which is based on the physical characteristics of the person: fingerprints, face, voice, eyes, etc. Behavioral biometrics is based on behavioral parameters specific to each person, such as the 5 rhythm of typing on a keyboard, pressure on keys or buttons of a keyboard, mouse movement, gestures, etc. Behavioral biometrics examines, for example, the patterns or properties specific to a person's movements in order to allow comparison with past behavior and authentication and/or identification. A behavioral model of a user is configured to receive, as input, values of characteristic parameters of the behavior of this user and to generate a score as output.

The behavior of the user refers here to the interaction actions (in particular gestures performed by means of one or more interaction elements) performed by this user.

The score is representative of a probability that the behavior represented by the input characteristic parameter values is that of the user associated with the behavioral model. The value of this score can be normalized, for example be between 0 and 1. By convention, it is assumed in this document that the higher the score, the higher the probability.

The scores obtained from the behavioral biometric models associated with the different users thus allow discrimination between users. This discrimination on the basis of scores is made all the more effective by the fact that the reference users themselves have behaviors that discriminate them from one another.

The solution is inexpensive in that it uses only the behavioral data produced by a user's action on one or more interaction devices (comprising various interaction elements such as one or more buttons, scroll wheels, joystick, mouse, touchscreen, etc.) during interaction with the application system, and does not require any additional sensors or additional measurements.

This method and device can be used in particular for video games, in the case where biometric behavioral data can be collected during the user's game sessions from the raw behavioral data produced by the game console (buttons and/or joystick) following the user's actions.

The authentication device allows continuous authentication of the user, for example throughout an interaction session. In the context of video games, this authentication can be carried out throughout a gaming session. It does not require any break in the interaction with the application system. Authentication is transparent to the user, requiring no specific actions on the part of the user. The authentication level is that of strong authentication.

The behavioral data collected are, for example, those generated by a user interface, such as an interaction device, control device or a control panel. In the case of a video game, this may be a game console including a keyboard and/or joystick or other interaction elements. Behavioral data typically include information on the actions (such as presses and releases) performed by means of the various interaction elements. There is no need to use special sensors such as an accelerometers or gyroscope. If sensors are available on the game console (accelerometer, gyroscope, etc.), these can be used to enrich the user's behavioral data, but are in no way essential for authentication.

The authentication method mainly comprises four phases:
a phase 1 of generating reference behavioral biometric models for reference users;
a phase 2 of enrolling one or more legitimate users comprising training a behavioral biometric model for these legitimate users;
a phase 3 in which the trained behavioral biometric model of a user is used to perform continuous authentication during an interaction with an application system;
a phase 4 in which the biometric template of a legitimate user can be updated with behavioral data acquired during phase 3.

In the present description, the terms behavioral model and behavioral biometric model will be used interchangeably to refer to a biometric model of the behavior of a given user, whether trained or not. The term biometric template will be used to refer to the trained behavioral biometric model.

Reference users can be any users or legitimate users who are different from the target legitimate user (the one whose model is to be trained or who is to be authenticated).

An impostor is a user who uses another user's account to play. In the context of this document, the focus is on the case of a user to be authenticated, who may be an impostor seeking to spoof the behavior of the account owner in order to avoid being unmasked, or the legitimate user, i.e. the owner of the user account used for the interaction session.

The user to be authenticated may also be a cheater, using various cheating methods, for example in a video game, to alter the rules of the game in order to gain an unfair advantage in a match or session.

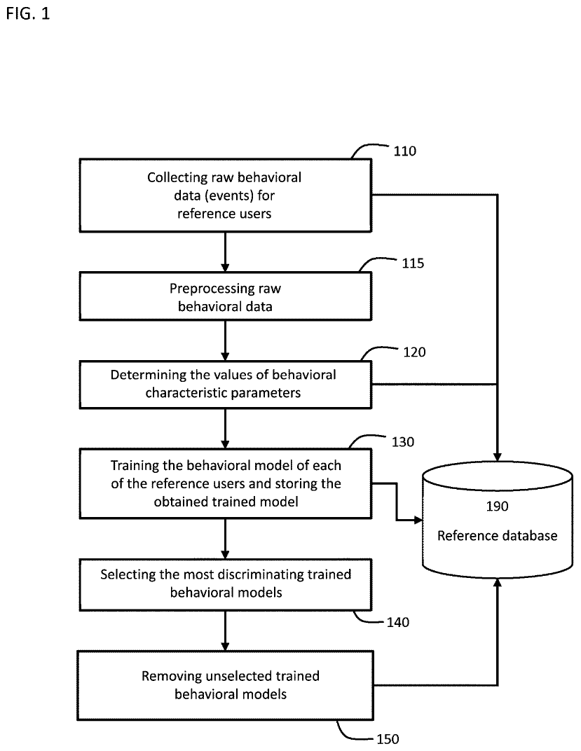

FIG. 1 shows a block diagram illustrating phase 1 of creating discriminating reference behavioral models for reference users. The reference behavioral models (more precisely, the coefficients of these reference behavioral models) are stored in a database, called reference database 190.

This reference database 190 contains the raw behavioral data acquired for the reference users, the behavioral characteristics extracted from these raw data and the biometric templates of the reference users (more precisely, the coefficients of these reference biometric templates).

The phase of creating the reference base 190 may comprise the following steps.

In step 110, raw behavioral data are collected during game sessions played by any users, referred to as reference users. These may be legitimate users with accounts who use the application system in real-life conditions.

These raw behavioral data correspond to a set of events representative of the interaction actions with the application system (in this case, the video game) performed by the user by means of one or more interaction devices (also called user interface devices here).

These interaction actions generate input data for the application system via a user interface of this application system. Raw behavioral data can be collected either during a time interval of predefined duration, or in such a way as to obtain a minimum number of events (e.g. 200, 300, 500 events).

These events correspond, for example, to button presses and releases, joystick or scroll wheel movements, etc.

An interaction action on a button may be a button press or button release, a double press, etc. An interaction action on a joystick, trackball or scroll wheel may be a press, a release, a movement or change of position (e.g. change of joystick axis or a trackball or scroll wheel rotation), etc. An interaction action on a touchscreen may be a press with one or more fingers, a tap or short press, a swiping movement, a rotating movement, a resizing movement or zoom in/out, etc. Interaction actions may be performed with a hand, or via a stylus or other object or body part.

Each event can be described by one or more descriptive parameters. For example, for each button, a button press can be described by the duration of the press, the force of pressure on the button, the rising or falling edge of the pressure variation curve, a press start time, a press release time, etc. For a joystick, it is possible to use the start position, the release position, the distance traveled, etc.

For an interaction action including a movement along a spatial path, the descriptive parameters of the interaction movement may include: a differential parameter or derivative (such as velocity or acceleration) determined for the movement, a Fourier transform, the duration of the movement, the spatial amplitude of the movement, the user's reaction time (the user's reaction time may be, for example, a time between two interaction actions, between a game instruction and the user's interaction action, between a starting position and a first interaction action), one or more spatial positions or spatial orientations of the interaction element, etc.

The collected raw behavioral data can undergo preprocessing in a step 115 (typically comprising cleaning, e.g. by removing noise or inconsistent data). The raw behavioral data are stored in reference database 190.

In step 120, in order to generate a biometric template specific to each user, the raw behavioral data collected or optionally preprocessed in step 115 are analyzed in order to extract therefrom values of characteristic parameters (“features”) of the user's behavior. These are also referred to as behavioral characteristics.

One or more of the characteristic parameters may include parameters that are descriptive of one or more interaction actions and/or from raw behavioral data acquired for one or more interaction elements. One or more of the characteristic parameters may be determined from parameters that are descriptive of one or more interaction actions and/or from raw behavioral data acquired for one or more interaction elements.

These characteristic parameters are, for example, statistical parameters determined over a time interval from one or more descriptive parameters of the detected events. Examples of statistical parameters include: minimum, maximum, mean, standard deviation or variance, frequency, periodicity, median value, etc. These characteristic parameters are determined for each of the time intervals in a sequence of time intervals. A time interval can have a duration ranging from 0.1 s to 3 s. It is also possible to group the events into sequences of at least N events and to determine the values of the characteristic parameters for each sequence, such that the statistical values calculated for the behavioral characteristics are significant. For example, values of the characteristic parameters are calculated for the first N events, then for the next N, and so on. For example, N=20, 30, 50, 100 is the number of events per sequence.

The next training step 130 may be carried out only when a minimum number G of sequences of events and the corresponding characteristic parameter values have been obtained. For example, G=5, 10, 20, 30, 50.

The characteristic parameter values thus obtained are stored in the reference database 190.

In step 130, biometric templates of the reference users are generated by training a behavioral model using the characteristic parameter values obtained in step 120. For each reference user, a biometric template (a trained behavioral model) specific to this reference user is generated using a machine learning algorithm to train the model. A trained behavioral model specific to a reference user is referred to as a “reference model”.

A behavioral model of a user is configured to receive, as input, values of characteristic parameters and to generate a score as output. The score is representative of a probability that the behavior represented by the input characteristic parameter values is that of the user associated with the behavioral model. The value of this score can be normalized, for example be between 0 and 1. By convention, it is assumed in this document that the higher the score, the higher the probability.

Different types of machine learning algorithms (supervised, unsupervised, semi-supervised, reinforcement-based, etc.) can be used to generate a behavioral model: for example, a neural network, a random forest, a boosting algorithm (e.g. XGBoost, Extreme Gradient Boosting), a support vector machine (SVM), a hidden Markov model (HMM), etc.

Various methods and models can thus be applied to determine the extent to which a user to be authenticated corresponds to a reference user, and to generate a corresponding score.

The score calculation methods can, for example, determine one or more reference vectors, comprising representative parameter values of the behavior of a reference user and acting as a biometric template for this reference user, and then compare these one or more reference vectors with a current vector, representative of the behavior of a user to be authenticated. The score calculation can be based on such vectors and a distance calculation, a barycenter of the reference vectors, a standard deviation calculation, classification and comparison of obtained labels, a probability calculation, etc.

Different training methods can be used, for example: supervised methods in which the data are labeled (known classes), unsupervised methods (unlabeled data), semi-supervised methods (labeled and unlabeled data).

In the example of the supervised method used here, training is carried out with data from the legitimate user that verify the hypothesis “the user is legitimate” and data from reference users (different from the target legitimate user) that verify the opposite hypothesis “the user is not legitimate”. The data from the target legitimate user are therefore labeled “legitimate” and the data from the reference users are labeled “non-legitimate”, in order to train the model to distinguish between the two classes (the behavior of the target legitimate user and that of an unknown user) and predict the correct class.

In step 140, reference users are selected so as to retain only those reference users whose behavior is highly discriminating with respect to the other reference users stored in the reference database 190. Various statistical analysis methods can be used for this purpose.

This selection is made, for example, through statistical analysis with cross-validation, measuring the false positive and false negative rates each time. This cross-validation can consist in comparing reference users two by two, for example by calculating a cross-score for a given user A's behavioral model by providing characteristic parameter values obtained for another user B as input to this behavioral model. Those users whose behavioral model generates a false positive rate (score rate above a threshold) that is too high and/or those users whose cross-score is always below a threshold are then identified.

In step 150, all of the data from reference users whose behavioral model is not sufficiently discriminating are deleted from the reference base 190, such that these users will not form part of the definitive reference database (raw behavioral data, behavior characteristic parameters and biometric templates) which will be used in particular in phases 2 and 3 because their behavior was not established as being sufficiently discriminating in step 140.

The reference users selected in this way may be any users and/or legitimate users. These are users with behavioral models that are insensitive and resistant to the behavior of impostors or unknown users.

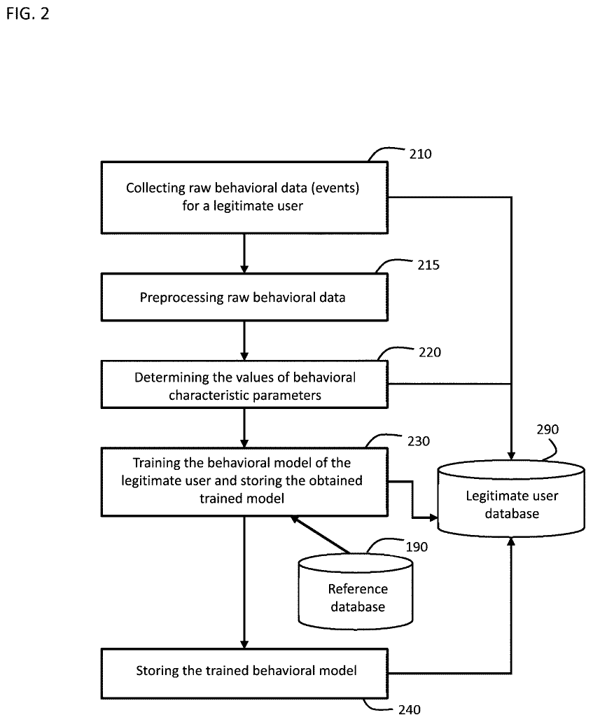

FIG. 2 shows a block diagram illustrating phase 2 of enrolling one or more legitimate users. This phase comprises training a behavioral biometric model for these legitimate users and creating a database of legitimate users, also called the legitimate user database 290.

This legitimate user database 290 comprises the raw behavioral data acquired for the legitimate users, the values of the behavioral characteristics extracted from these raw data and the biometric templates of the legitimate users (more precisely, the coefficients of these biometric templates). For each legitimate user, the steps of enrollment can include the following.

In step 210, raw behavioral data are collected during game sessions played by this legitimate user. This step is similar to step 110 described above, but is carried out during game sessions played by this legitimate user.

The collected raw behavioral data can undergo preprocessing in a step 215, similar to that of step 115. The raw and preprocessed behavioral data are stored in the legitimate user database 290.

In step 220, in order to generate a biometric template specific to each legitimate user, the raw behavioral data collected in step 210 or preprocessed data obtained in step 215 are analyzed in order to extract therefrom values of characteristic parameters of this user's behavior. This step is similar to step 120 described above for the reference users; in particular, the same characteristic parameters can be used as for the reference users. The characteristic parameter values are stored in the legitimate user database 290 for use in step 230 but also later in phase 4 for updating the legitimate user's biometric template following successful authentication.

In step 230, a biometric template of the legitimate user is generated. This step uses the characteristic parameters of the legitimate user, generated in the preceding step 220, but also the characteristic parameters of the reference users obtained in step 120 and stored in the reference user database 190. The characteristic parameter values of the reference users in this database constitute a representative reduced set of behaviors, allowing faster training than when using characteristic parameter values for all of the other users. In order to train the behavioral model to differentiate a given target legitimate user from another user (be it another legitimate user, an impostor or an unknown user) and to ensure that the training data are balanced, the same number of reference user characteristic parameters as legitimate user characteristic parameters are used to train the model of the legitimate user.

The biometric template is obtained by training a behavioral model based on a machine learning algorithm.

The same type of behavioral model is used for the reference users and with the same training method, except that the behavioral model of a target reference user A is trained with the characteristic parameters of the reference user A (which represent the legitimate user class) and the characteristic parameters of the other reference users (which represent the illegitimate user class).

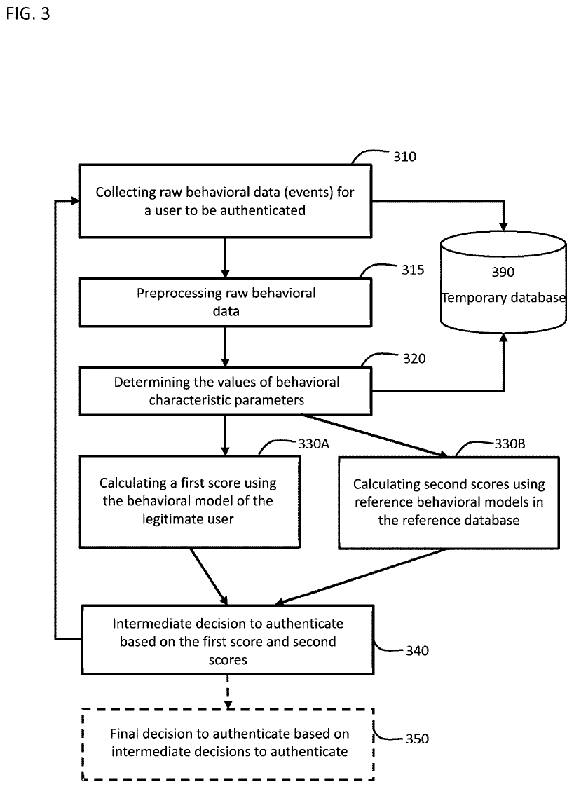

In step 240, the legitimate user's biometric template is stored in the legitimate user database 290 for later use in phase 3 of authentication. FIG. 3 shows a block diagram illustrating phase 3 of authenticating a user. The purpose of this phase is to authenticate any user (legitimate or otherwise) using a user account for which a biometric template was previously obtained for its legitimate owner in phase 2.

The user to be authenticated may therefore be the legitimate user, i.e. the owner of the user account being used. It may be an impostor, fraudulently using this user account and any associated payment means, for example to avoid paying themself. It may also be a user who has obtained (fraudulently or otherwise) the login details for this user account and is using this account to play, with or without the consent of the owner of the user account. it may also be a user (e.g. a child or a friend) who does not have the login data for a user account but who, after being logged in by the owner of the user account, is authorized to use this user account to play.

This authentication can be carried out continuously, throughout the interaction session with the application system (the game in this case), by comparing their biometric behavior with that of the legitimate user, who is the owner of the user account via which the user to be authenticated interacts with the application system.

Phase 3 of authenticating a user may comprise the following steps.

In step 310, raw behavioral data are collected when the user to be authenticated interacts with the application system. This step is similar to step 110 described above, but is carried out during the current interaction session.

The collected raw behavioral data can undergo preprocessing in a step 315, similar to that of step 115. The raw and preprocessed behavioral data are stored in a temporary database, also called the temporary database 390.

This temporary database 390 comprises the raw behavioral data acquired for the users to be authenticated and the values of the behavioral characteristics extracted from these raw data, and the authentication score values obtained on the basis of these values.

In step 320, the raw behavioral data collected in step 310 or preprocessed data obtained in step 315 are analyzed in order to extract therefrom 20) values of characteristic parameters of this user's behavior. This step is similar to step 120 described above for the reference users; in particular, the same characteristic parameters can be used as for the reference users. The values of the characteristic parameters are stored in the temporary database 390 for use in the following steps 330A, 330B, 340 but also in phase 4 for updating the legitimate user's biometric template in the event of successful authentication with a sufficiently high level of confidence at the end of phase 3.

In a step 330A, the characteristic parameter values obtained in step 320 are tested against the biometric template obtained in phase 2 for the legitimate user who owns the user account currently being used. To this end, the characteristic parameter values are supplied as input to the legitimate user's biometric template so as to obtain a first score as output. This first score represents a probability that the user to be authenticated is the legitimate user.

In a step 330B, the characteristic parameter values obtained in step 320 are tested against the biometric template obtained in phase 1 for each of the reference users with the most discriminating behavioral models as selected in step 150. To this end, the characteristic parameter values are supplied as input to each reference user's biometric template so as to obtain scores as output. Each of these scores (also referred to here as “second scores” or “reference scores”) represents a probability that the user to be authenticated is the reference user associated with the behavioral model used to generate the score.

In step 340, the scores obtained in steps 330A and 330B, respectively, are analyzed in order to make a decision to authenticate, i.e. to determine whether or not the user to be authenticated is the legitimate user. Different methods can be used to combine these scores in order to make the decision to authenticate. An authentication threshold is defined for all of the scores. This score may be equal to 0.5 or 0.6 or 0.7 or 0.75 or 0.8, for example. The authentication threshold can be set according to a plurality of parameters, such as a desired level of security, the level of risk associated with illegitimate use of a user's account, etc.

If the first score obtained in step 330A during the comparison with the legitimate user is below the authentication threshold, the behavior is considered to be different from that of the legitimate user and the user to be authenticated is not recognized as being the legitimate user (authentication failure).

If the first score obtained in step 330A during the comparison with the legitimate user is above the authentication threshold and one or more reference scores obtained in step 330B during the comparisons with the reference users are above the authentication threshold, the behavior is considered to be that of an unknown user and the user to be authenticated is not recognized as being the legitimate user (authentication failure).

If the comparison score with the legitimate user is above the authentication threshold and none of the reference scores obtained in step 330B during the comparisons with the reference users is above the authentication threshold, the behavior is considered to be that of the legitimate user and the user to be authenticated is recognized as being the legitimate user (successful authentication).

Cases where a score is equal to the authentication threshold can be treated as cases where the score is below the authentication threshold, or as cases where the score is above the authentication threshold.

Alternatively, an integer N strictly greater than 1, for example less than 10 (for example N=2 or 3 or 5) is defined and the decision to authenticate is made as follows:
if the first score obtained in step 330A is lower than the authentication threshold, authentication fails;
if the first score is above the authentication threshold and fewer than N reference scores are above the authentication threshold, authentication is successful;
if the first comparison score with the legitimate user is above the authentication threshold and N or more reference scores are higher than the authentication threshold, authentication fails.

Steps 310 to 340 of authenticating a user can be repeated continuously throughout the interaction session with the application system, for example periodically, in which case the characteristic parameter values are calculated for a time interval of given duration and/or for a minimum number of detected interaction events. This allows a decision to authenticate to be available at any time throughout an interaction session and any change of user during the interaction session to be detected.

This repetition also makes it possible to detect the temporal concatenation of a plurality of positive decisions to authenticate (successful authentication) in a row (without any time interval with authentication failure) obtained, respectively, in a plurality of steps 340, and to base the final decision to authenticate (step 350) on a set of decisions to authenticate obtained independently for separate time intervals.

By basing the final decision to authenticate in step 350 on a plurality of intermediate decisions to authenticate obtained in step 340, a stronger authentication level can be provided, corresponding to a higher security level if, for example, the final decision to authenticate obtained in step 350 is positive at a given time only if all of the intermediate decisions to authenticate obtained for time intervals within a time period preceding this time are also positive.

This repetition can also be used to add a bonus/malus mechanism that modifies the current prediction over a given time interval according to previous intermediate decisions to authenticate over the preceding time intervals.

A positive or negative weight P is added to the score depending on whether a bonus or a malus is to be applied. This weight P is continuously updated during the interaction session according to the obtained scores. The weight is set to 0 at the start of the interaction session. It is also reset to 0 after a period of inactivity by the user to be authenticated. The weight has a minimum value Pmin and a maximum value Pmax which it can never exceed, e.g. Pmin=−0.5 and Pmax=0.2.

The mechanism may be as follows for each authentication score newly obtained in step 330A for a given time interval:
if one of the reference scores is higher than the authentication threshold, a negative increment (malus, equal to P1=−0.1 for example) is applied to the weight: P=P+P1;
otherwise, if the first score produced by the model of the legitimate user is higher than the authentication threshold, a positive increment (bonus equal to P2=+0.01 for example) is applied to the weight: P=P+P2;
The first score obtained for a given time interval in step 330A is thus modified by adding the current value of the weight to obtain the score used for the decision to authenticate in step 340, this modified score being compared with the authentication threshold.

This makes the predictions at a given point in time more accurate by adding additional information linked to the behavioral data from previous predictions to the decision-making process.

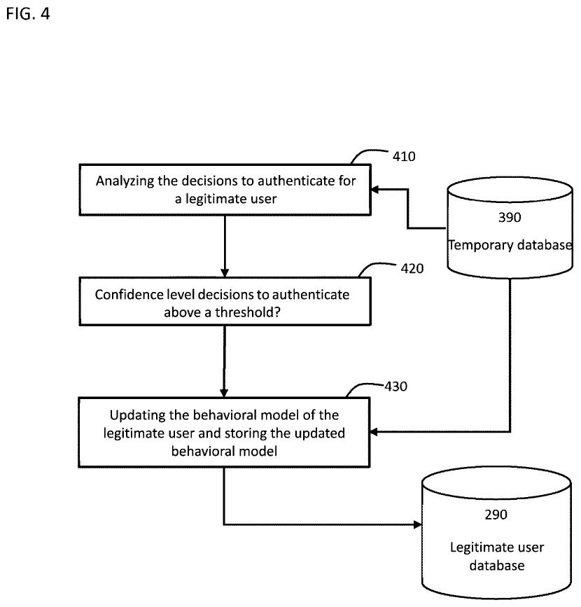

FIG. 4 shows a block diagram illustrating phase 4 of updating the biometric template of a legitimate user.

This updating of the biometric template of a legitimate user is carried out in the event of successful authentication with a sufficiently high level of confidence in phase 3 (intermediate decision to authenticate in step 340 or final decision to authenticate in step 350). This makes it possible to adapt to any changes in the legitimate user's behavior over time, and to have a biometric template that is very close to the user's behavior. The phase of updating of the biometric template may comprise the following steps.

In step 410, at the end of the interaction session (the end of a gaming session, for example), all of the decisions to authenticate (intermediate and final) obtained in step 340 and, optionally, step 350 are stored in the temporary database 390 and analyzed.

In step 420, if the confidence level of the decisions to authenticate during the session is sufficiently high (above a certain threshold set beforehand), the data stored in the temporary database 390 (raw collected data and the extracted characteristic parameter values) are then transferred to the legitimate user database 290. The confidence level can be assessed in different ways. The confidence level can be equal to the minimum authentication score produced by the model of the legitimate user over the course of their entire session. The confidence level is then compared with a threshold set beforehand to determine whether or not step 430 is carried out.

In step 430, if the determination in step 420 is positive, the legitimate user's biometric template is updated. In step 430, the legitimate user's biometric template is recalculated taking into account the new values of the extracted characteristic parameters that have just been added to their profile. The behavioral model of the legitimate user is completely retrained as in step 230, but while taking into account the new values of the characteristic parameters that have just been added to their profile. Alternatively, it is possible to delete some of the old characteristic parameter values (in order to keep only the most recent data and avoid scalability problems and storing large quantities of data) before retraining the model.

When the invention is applied to video games, the user's behavior may depend on the video game or type of video game. To allow reliable prediction, it is possible to train a behavioral model specific to each video game or each type of video game. The specific behavioral model is then used to authenticate a legitimate user.

In addition, from one or more behavioral models specific to one or more games of a user, a meta-model can be generated for a given user that can act as a starting point for training a new behavioral model specific to a given game. To generate this meta-model, the data from a legitimate user collected across different games indiscriminately along with their data from navigating game and/or console menus can be used as well as the data from reference users across all games indiscriminately along with their navigation data by applying one of the training methods described above.

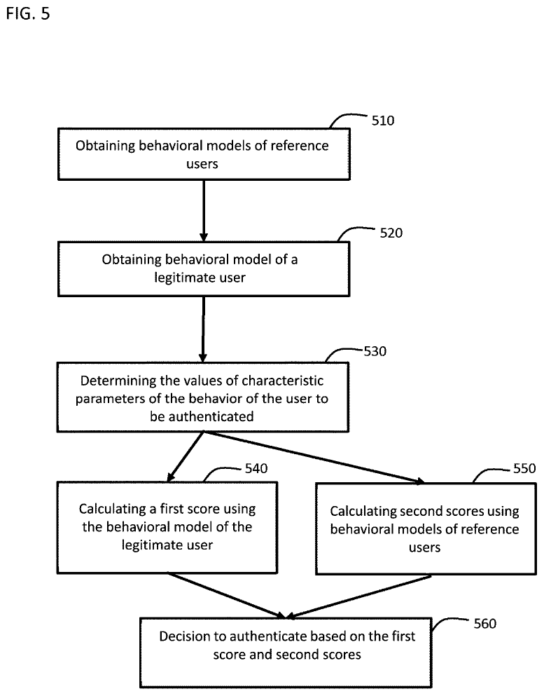

FIG. 5 shows a general flowchart of a method for behavioral biometric authentication of a user interacting with an application system by means of at least one interaction device.

The application system is, for example, a video game system. The method for behavioral biometric authentication can be implemented by a corresponding device for behavioral biometric authentication comprising means for implementing this method, this device being interconnected with the application system.

In step 510, behavioral models of reference users are obtained. The behavioral models of the reference users can be the most discriminating behavioral models from among a set of reference user behavioral models. The reference users are, for example, any users other than the legitimate user. These behavioral models or biometric templates can be obtained as described with reference to FIG. 1.

In step 520, a behavioral model of a legitimate user is obtained. This behavioral model or biometric template can be obtained as described with reference to FIG. 2.

In a step 530, values of characteristic parameters of the user's behavior which are calculated from events produced by the user's interaction actions with the interaction device are obtained. These characteristic parameter values can be obtained as described with reference to FIG. 3.

In a step 540, a first score is determined by applying the behavioral model of the legitimate user to the values of the characteristic parameters. The first score represents, for example, a probability that the user is the legitimate user.

In a step 550, second scores are determined by applying each of the behavioral biometric models of the reference users to the values of the characteristic parameters. Each second score can represent a probability that the user is the reference user associated with the behavioral model used to generate the considered score.

In a step 560, a decision to authenticate the user as being the legitimate user is taken on the basis of the first score and the second scores. The decision to authenticate may be negative if the first score is below an authentication threshold. The decision to authenticate may be negative if the first score is above an authentication threshold and at least one of the second scores is above the authentication threshold. The decision to authenticate may be positive if the first score is above an authentication threshold and all of the second scores are below the authentication threshold.

Alternatively, an integer N strictly greater than 1 is defined. For example, N is smaller than or equal to 10. For example, N=2, 3 or 5. The decision to authenticate is:
negative if the first score is below the authentication threshold;
positive if the first score is above an authentication threshold and fewer than N second scores are above the authentication threshold;
negative if the first score is above an authentication threshold and at least N or more second scores are above the authentication threshold.

For steps 540, 550 and 560, embodiment details described, for example, with reference to FIG. 3 (in particular steps 330A, 330B, 340) can be used.

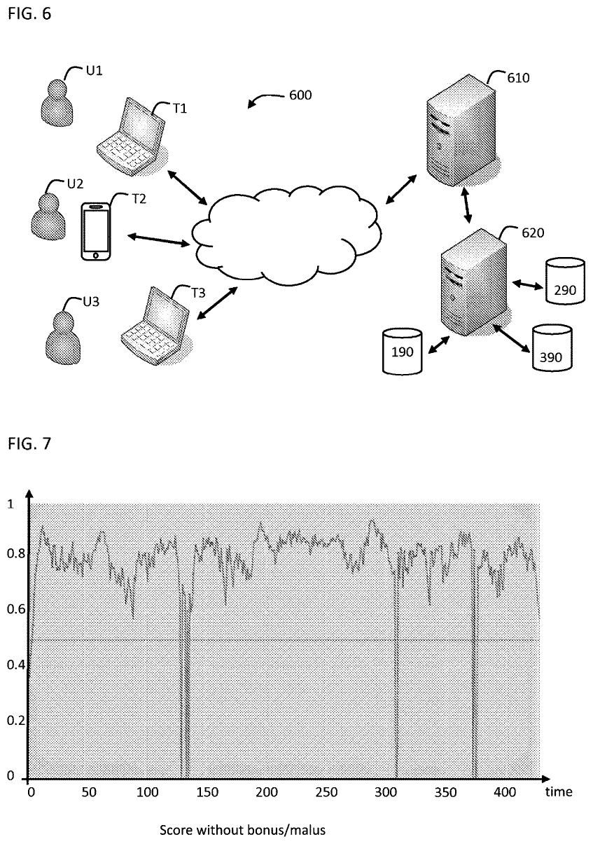

FIG. 6 schematically shows a system 600 including a behavioral biometric authentication device according to one exemplary embodiment.

The system includes a plurality of user devices T1, T2, T3 used by respective users U1, U2, U3. The user devices T1, T2, T3 communicate by means of an application through at least one communication network with an application system 610, for example a video game server 610.

Interaction with the video game can take place via the user interface of one of the user devices T1, T2, T3, or via a dedicated interaction device (not shown) for the game (joystick, dedicated game keyboard, scroll wheel, console, etc.).

A behavioral biometric authentication device 620 is operatively connected to this video game server 610 and comprises means for implementing a behavioral biometric authentication method as described in this document.

This behavioral biometric authentication device 620 accesses one or more databases, comprising for example a reference database 190 for reference users, a database 290 of legitimate users and a temporary database 390 for users to be authenticated, as described in this document, for example with reference to FIGS. 1 to 5.

### Applications

The behavioral biometric authentication solution described in this document can be used, for example, to allow continuous strong authentication throughout a video game so as to validate (optionally automatically or after confirmation by the user who is the account holder) the execution of a payment transaction following a positive decision to authenticate, without the user having to enter authentication data or use any device other than the device for interaction with the video game (console).

The authentication solution can also be used for parental control in order to protect children, or to unlock user accounts on game consoles (the account can lock automatically if the behavior is not that of the legitimate user).

### Experimental Results in the Video Game Field.

Tests were carried out with a set of around 200 to 250 behavioral features based solely on buttons and joysticks, and without using raw data from gyroscopes or other sensors.

The length N of the sequences of events can vary in order to obtain more precise statistical characteristics.

After training using a random forest with these features, it was possible to achieve an equal error rate (EER) of just 0.3%. The EER corresponds to the error rate when the false acceptance rate (FAR) is equal to the false rejection rate (FRR). The authentication threshold for the scores was adapted to lower either the FRR (better user experience) or the FAR (better security).

It is apparent that a single enrollment session (phase 2) may be sufficient to authenticate/identify the user directly in a future gaming session, but a second enrollment session in which the behavioral model is trained again reduces any risk.

By using a sliding window over 500 events to obtain a final decision to authenticate, it is possible to identify the user very precisely and detect a change of user within around 5 to 10 seconds of play. Identifying the new user can take up to 5 to 10 additional seconds. This time can be reduced depending on the accuracy requirements of the authentication device.

The user's behavioral model can be updated with new data in order to track the user's progress, as a change in behavior often occurs as the user gets better at the game.

Behavioral models also become more robust when trained across different game modes, as the actions performed by the user may differ depending on the game mode. However, it is possible to authenticate a player across these game modes by starting from a behavioral model obtained for a specific first game mode. It is possible to increase the authentication threshold when the game mode changes.

The reference user database can also be updated to take account of the emergence of new types of behavior among users, and to identify new reference users with discriminating behavioral models. In general, the use of reference models for reference users makes it possible to check whether or not the behavior of the user to be authenticated is similar to one of these reference users. Thus, instead of using only the behavioral model of the legitimate user, a contrario verification is carried out on the basis of the reference models.

Comparison of the performance indicators of a basic method, without reference users, with the method described here using reference users.

The performance indicators used are the false rejection rate and the false acceptance rate. The experiments are run on the same test set with the same users to generate biometric templates for each user. To carry out the experiment, 12 independent users were used in both cases, who played for two to three sessions of around 10 minutes each, i.e. a little over 4 hours of play. Consequently, there is no bias between the basic method and the proposed method other than the use of reference users.

The confusion matrix obtained for the basic method is as follows:

TABLE 1

| | Predicted class: | Predicted class: non- |
|---|---|---|
| | legitimate user | legitimate user |
| Actual class: | 287 (True Acceptances) | 5 (False Rejections) |
| legitimate user | | |
| Actual class: non- | 1906 (False Acceptances) | 16043 (True Rejections) |
| legitimate user | | |

The confusion matrix obtained for the method described in this document with reference users is as follows:

TABLE 2

| | Predicted class: | Predicted class: non- |
|---|---|---|
| | legitimate user | legitimate user |
| Actual class: | 255 (True Acceptances) | 37 (False Rejections) |
| legitimate user | | |
| Actual class: non- | 6 (False Acceptances) | 17943 (True Rejections) |
| legitimate user | | |

Comparing the two methods, the following ratios are obtained:

TABLE 3

| | Basic method | With reference users |
|---|---|---|
| False rejection | 1.74% | 12.85% |
| rate ratio (%) | | |
| False acceptance | 11.88% | 0.04% |
| rate ratio (%) | | |

Insofar as the authentication system seeks to provide a higher level of security, it is the false acceptance rate that is mainly of interest (an impostor who manages to pass themself off as the legitimate user).

The false rejection rate rose from 1.74% to 12.85%, corresponding to a multiplication factor of 7.4. However, the false acceptance rate fell from 11.88% to 0.04%, corresponding to a division factor of 297.

The system with reference users therefore provides a much higher level of security while maintaining the same authentication threshold.

As far as the false rejection rate is concerned, it can be shown that weighting the score using a bonus/malus system as described in this document reduces the false rejection rate by using a temporal sequence of a plurality of scores.

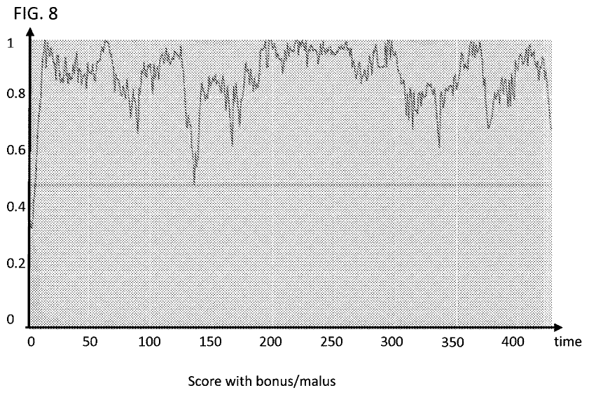

FIGS. 7 and 8 show the variation with time over a period of around 400 seconds in the authentication score with and without bonus/malus. These figures illustrate the improvement in the score (between 0 and 1) obtained by weighting with a bonus/malus system. The horizontal line on the graphs corresponds to an authentication threshold arbitrarily set at 0.5 for the experiment.

The change with time in a legitimate user's final score over a gaming session using the method with reference users without a bonus/malus system is illustrated in FIG. 7. Several peaks can be seen in which the value of the score is below the threshold, thus leading to false rejections in these periods.

Using the bonus/malus system to weight the final score, it can be seen in FIG. 8 that the score remains above the authentication threshold, thereby avoiding the occurrence of false rejections with this value for the authentication threshold. This bonus/malus system therefore reduces the false rejection rate. It can therefore be used to correct a negative decision to authenticate.

Each of the phases 1 to 4 that are described corresponds to a method that can be implemented independently of the other methods. Each of the steps in the various phases that are described can also form part of a behavioral biometric authentication method, and one or more or all of the steps in the various phases can be combined in various ways to implement this behavioral biometric authentication method.

In the description of the various phases and methods for behavioral biometric authentication, although the steps are described sequentially, a person skilled in the art will understand that some steps may be omitted, combined, performed in a different order and/or in parallel.

One or more or all of the steps in one or more of the methods described in this document can be implemented by software or a computer program and/or by hardware, e.g. by circuitry, whether programmable or not, specific or not.

The functions, steps and methods described herein can be implemented by software (for example, via software on one or more processors, for execution on a general-purpose or special-purpose computer) and/or implemented by hardware (for example, one or more electronic circuits, and/or any other hardware component).

The present description thus relates to a computer program or software, capable of being executed by a host device (for example, a computer) acting as a behavioral biometric authentication device, by means of one or more data processors, this program/software comprising instructions for causing said host device to execute all or some of the steps of one or more of the methods described in this document. These instructions are intended to be stored in a memory of the host apparatus, loaded and then executed by one or more processors of this host apparatus so as to cause this host apparatus to execute the considered method.

This software/program may be coded using any programming language, and may be in the form of source code, object code, or intermediate code between source code and object code, such as in a partially compiled form, or in any other desirable form.

The host apparatus can be implemented by one or more physically separate machines. The host apparatus may have the overall architecture of a computer, including the components of such an architecture: data memory (ies), processor(s), communication bus(es), hardware interface(s) for connecting this host apparatus to a network or other device, user interface(s), etc.

In an embodiment, some or all of the steps of the behavioral biometric authentication method or of another method described in this document are implemented by a behavioral biometric authentication device provided with means for implementing those steps of that method.

These means may comprise software means (for example instructions of one or more program components) and/or hardware means (for example data memory(ies), processor(s), communication bus, hardware interface(s), etc.).

These means may comprise, for example, one or more circuits configured to execute one or more or all of the steps of one of the methods described herein. These means may comprise, for example, at least one processor and at least one memory comprising program instructions configured to, when executed by the processor, cause the apparatus to perform one, more or all of the steps of one of the methods described herein.

Means implementing a function or a set of functions may also refer in this document to a software component, a hardware component or a set of hardware and/or software components, able to implement the function or the set of functions, as described below for the means concerned.

The present description also relates to an information medium readable by a data processor, and having instructions of a program as mentioned above.

The information medium may be any hardware means, entity or device, capable of storing the instructions of a program as mentioned above. Usable program storage media include ROM or RAM memories, magnetic storage media such as magnetic disks and tapes, hard drives or optically readable digital data storage media, etc., or any combination thereof.

In some cases, the computer-readable storage medium is not transitory. In other cases, the information medium may be a transient medium (for example, a carrier wave) for the transmission of a signal (electromagnetic, electrical, radio or optical signal) carrying program instructions. This signal can be conveyed via an appropriate transmission medium, wired or wireless: electrical or optical cable, radio or infrared link, or by other means.

An embodiment also relates to a computer program product comprising a computer-readable storage medium having program instructions stored thereon, the program instructions being configured to cause the host apparatus (for example a computer) to implement some or all of the steps of one or more of the methods described herein when the program instructions are executed by one or several processors and/or one or more programmable hardware components of the host apparatus.

1. A method comprising
obtaining (510) behavioral biometric models of reference users;
obtaining (520) a behavioral biometric model of a legitimate user, wherein the behavioral biometric model of a legitimate user, respectively of a reference user, is configured to receive, as input, values of characteristic parameters of the behavior of the considered user during interaction actions with an interaction device and to generate, as output, a score representative of a probability that the behavior represented by the input characteristic parameter values is that of the considered user;
obtaining (530) values of characteristic parameters of a behavior of a user to be authenticated, wherein the obtained values are determined from events produced by interaction actions carried out—with the interaction device by the user to be authenticated;
determining (540) a first score by applying the behavioral biometric model of the legitimate user to the obtained values of the characteristic parameters;
determining (550) second scores by respectively applying each of the behavioral biometric models of the reference users to the obtained values of the characteristic parameters;
determining (560) a decision to authenticate the user to be authenticated as being the legitimate user on the basis of the first score and the second scores.

2. The method as claimed in claim 1, wherein the first score represents a probability that the user is the legitimate user.

3. The method as claimed in claim 1, wherein each second score represents a probability that the user is a reference user associated with the behavioral model used to generate the considered second score.

4. The method as claimed in claim 1, wherein the steps of determining the first score, the second scores and the decision to authenticate are repeated for characteristic parameter values respectively obtained for a temporal sequence of time intervals, the method comprising
updating the current value of a weight for each time interval, the weight being decremented if one of the second scores obtained for this time interval is greater than an authentication threshold, the weight being incremented if the first score obtained for this time interval is greater than the authentication threshold;
the first score obtained for a time interval being modified by adding the current value of the weight after updating for this time interval, the modified first score being used to determine the decision to authenticate.

5. The method as claimed in claim 1, wherein
the decision to authenticate is negative if the first score is below an authentication threshold;
the decision to authenticate is negative if the first score is above an authentication threshold and at least one of the second scores is above the authentication threshold; and
the decision to authenticate is positive if the first score is above an authentication threshold and all of the second scores are below the authentication threshold.

6. The method as claimed in claim 1, wherein
the decision to authenticate is negative if the first score is below an authentication threshold;
the decision to authenticate is positive if the first score is above an authentication threshold and fewer than N second scores are above the authentication threshold;
the decision to authenticate is negative if the first score is above an authentication threshold and at least N or more second scores are above the authentication threshold;
N being an integer strictly greater than 1 and smaller than or equal to 10.

7. The method as claimed in claim 1, wherein the reference users are users different from the legitimate user.

8. The method as claimed in claim 1, wherein the behavioral models of the reference users are the most discriminating behavioral models from among a set of reference user behavioral models.

9. The method as claimed in claim 1, wherein the application system is a video game system.

10. A device comprising at least one processor and at least one memory, storing program instructions that, when executed by the at least one processor, cause the device to carry out:
obtaining (510) behavioral biometric models of reference users;
obtaining (520) a behavioral biometric model of a legitimate user, wherein the behavioral biometric model of a legitimate user, respectively of a reference user, is configured to receive, as input, values of characteristic parameters of the behavior of the considered user during interaction actions with an interaction device and to generate, as output, a score representative of a probability that the behavior represented by the input characteristic parameter values is that of the considered user;
obtaining (530) values of characteristic parameters of a behavior of a user to be authenticated, wherein the obtained values are determined from events produced by interaction actions carried out—with the interaction device by the user to be authenticated;
determining (540) a first score by applying the behavioral biometric model of the legitimate user to the obtained values of the characteristic parameters;
determining (550) second scores by respectively applying each of the behavioral biometric models of the reference users to the obtained values of the characteristic parameters;
determining (560) a decision to authenticate the user to be authenticated as being the legitimate user on the basis of the first score and the second scores.
